(19) United States
(12) Patent Application Publication
(10) Pub. No.: US 2010/0290143 A1
(43) Pub. Date: Nov. 18, 2010

(54) Color filter and apparatus and method of manufacturing the same

(75) Inventors: Jeong Gil Kim, Suwon-si (KR); Young Tae Cho, Suwon-si (KR); Suk Won Lee, Yongin-si (KR); Sin Kwon, Suwon-si (KR); Ki Hyun Kim, Yongin-si (KR); Jung Woo Seo, Hwaseong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,478

(22) Filed: Apr. 20, 2010

(30) Foreign Application Priority Data
May 18, 2009 (KR) 10-2009-0042972

(51) Int. Cl. G02B 5/22; B05D 5/06; B05C 1/08; G02B 1/04

(52) U.S. Cl. 359/891; 427/162; 118/258

(57) ABSTRACT

Disclosed herein are a color filter having a black matrix and an apparatus and method of manufacturing the same. The method may include applying an organic film to a substrate, forming a pattern on the organic film by applying pressure to the organic film with a mold having prominences and depressions, and forming a black matrix by applying an ink to the pattern of the organic film. The formation of the black matrix may be achieved by a roll to roll method. The black matrix is easily formed by carrying out imprinting and printing on the organic film applied to the substrate. The black matrix may have a fine line width of a nano level by imprinting and printing. Further, since the black matrix is formed by the roll to roll method, material costs may be reduced and the color filter may be manufactured at a relatively high speed.

### CROSS-REFERENCE TO RELATED APPLICATION

This application claims priority under 35 U.S.C. §119 to Korean Patent Application No. 2009-0042972, filed on May 18, 2009 in the Korean Intellectual Property Office (KIPO), the entire contents of which are herein incorporated by reference.

### BACKGROUND

1. Field

Example embodiments relate to a color filter having a black matrix, and an apparatus and method of manufacturing the same to simplify a manufacturing process and reduce manufacturing costs.

2. Description of the Related Art

Flat panel displays (FPDs) are characterized as being relatively lightweight and miniaturized when compared with cathodes ray tubes (CRTs). FPDs are also characterized as having a relatively large-sized screen. Plasma display panels (PDP) and a liquid crystal displays (LCD) are examples of a FPDs and each of the PDPs and LCDs are used in portable phones, personal digital assistants (PDAs), digital cameras, camcorders, laptop monitors, desktop monitors, and televisions.

Among the FPDs, an LCD allows a white ray emitted from a backlight unit to pass through liquid crystal cells such that the transmissivity of the white ray is adjusted, and then mixes rays obtained by passing through a color filter of red (R), green (G), and blue (B) layers, being adjacent to each other, thereby displaying an image. Here, the color filter includes a substrate, red (R), green (G), and blue (B) layers formed on the substrate, and a black matrix to divide R, G, and B cells from each other and block light.

In the manufacture of the color filter, chrome is deposited on the entire upper surface of the substrate. A photoresist pattern is located at partial regions of the upper surface of the chrome layer by applying photoresist on the upper surface of the chrome layer and then exposing and developing the photoresist. Thereafter, a black matrix (BM) pattern is formed by etching the exposed regions of the chrome layer by an etching process using the photoresist pattern as an etching mask, and then removing the photoresist pattern. Thereafter, a photosensitive film including a red pigment is applied to the substrate provided with the black matrix pattern, and the photosensitive film is exposed to light using a mask to be formed in a designated pattern. Thereafter, the photosensitive film formed in the pattern is developed, and the developed photosensitive film is hardened to form a red layer. In the same manner, blue and green layers are formed using photosensitive films respectively including blue and green pigments.

In the above color filter manufacturing method, since the color layers exhibiting the respective colors are formed using photolithography, a manufacturing process is relatively complicated and requires a relatively long time. Further, since equipment for photolithography is expensive and bulky, the above method causes a difficulty in preparing the equipment and a problem of installing the equipment in a space. Moreover, since the photosensitive films having specific colors are applied to the entire surface of the substrate and then most of the photosensitive films are removed, a waste of materials is relatively severe.

### SUMMARY

Example embodiments provide a color filter having a black matrix, and an apparatus and method of manufacturing the same to simplify a manufacturing process and reduce manufacturing costs.

Additional aspects of example embodiments will be set forth in part in the description which follows and, in part, will be obvious from the description, or may be learned by practice of the disclosure.

In accordance with example embodiments, a method of manufacturing a color filter may include forming an organic film on a substrate, forming a pattern on the organic film by applying pressure to the organic film with a mold having prominences and depressions, and forming a black matrix and a plurality of color cells by applying ink to the pattern on the organic film.

In accordance with example embodiments, an apparatus for manufacturing a color filter may include a pattern processing unit configured to apply pressure to an organic film on a substrate to form a plurality of barrier parts on the organic film, and an ink processing unit configured to apply an ink to the plurality of barrier parts to form a black matrix.

In accordance with example embodiments, a color filter may include a substrate and an organic film on the substrate. In example embodiments, the organic film may have an uneven pattern. In accordance with example embodiment, the color filter may further include a black matrix on the uneven pattern and color cells in the uneven pattern.

In accordance with example embodiments, a method of manufacturing a color filter may include applying an organic film to a substrate, forming a pattern on the organic film by applying pressure to the organic film with a mold having prominences and depressions, and forming a black matrix by applying an ink to the pattern of the organic film.

The application of pressure to the organic film with the mold may include applying a release agent to the mold having the prominences and the depressions.

The formation of the pattern on the organic film may include forming a plurality of barrier parts and groove parts on the organic film.

The formation of the black matrix pattern may include forming the black matrix on the plurality of barrier parts, and forming color cells on the plurality of groove parts.

The formation of the color cells may be achieved by any one method selected from the group consisting of an ink-jet method and a gravure printing method and a flexo printing method using a roller.

The application of pressure to the organic film with the mold having the prominences and depressions may include performing printing, in which a mold roller having the prominences and depressions applies pressure to the organic film.

The application of the ink to the pattern of the organic film may include printing the ink on the organic film using a blanket roller, to which the ink is applied.

The printing may be achieved by a roll to roll method, in which the substrate moves using transfer rollers.

The formation of the pattern on the organic film may include hardening the pattern of the organic film by providing heat or light to the pattern of the organic film.

In accordance with example embodiments, an apparatus of manufacturing a color filter may include a substrate, to which an organic film is applied, a pattern processing unit to apply pressure to the organic film to form a plurality of barrier parts on the organic film, and an ink processing unit to apply an ink to the plurality of barrier parts to form a black matrix.

The pattern processing unit may include an uneven sheet having a plurality of prominences and depressions, and the plurality of barrier parts may form a pattern of the black matrix corresponding to the shape of the uneven sheet.

The apparatus may further include another ink processing unit to discharge inks of the three primary colors to the plurality of groove parts formed between the plurality of barrier parts to form color cells on the organic film.

The apparatus may further include a transfer unit including transfer rollers and a transfer belt wound on the transfer rollers and moving by the rotations of the transfer rollers, the substrate may be seated on the transfer belt of the transfer unit, and the pattern processing unit and the ink processing unit may be installed at one side of the transfer unit.

The pattern processing unit may include a mold roller having an uneven sheet having a plurality of prominences and depressions.

The pattern processing unit may include a hardening unit to harden the organic film.

The ink processing unit may include a blanket roller, to which the ink is applied, to print the ink to the organic film.

The ink processing unit may further include an adjust roller separated from the blanket roller by a designated interval to adjust the thickness of the ink applied to the blanket roller and a blade contacting the adjust roller to remove the ink adhered to the adjust roller.

In accordance with example embodiments, a color filter may include a substrate, an organic film formed on the substrate and having an uneven pattern, a black matrix formed by printing a first ink on the uneven pattern, and color cells formed by injecting second inks into the uneven pattern.

The organic film may be made of a transparent organic material.

The substrate may be a glass substrate, or a flexible substrate made of any one selected from the group consisting of polyethylene terephthalate (PET), polyethylene naphthalene (PEN), or polyether sulfone (PES).

### BRIEF DESCRIPTION OF THE DRAWINGS

Example embodiments will become apparent and more readily appreciated from the following description, taken in conjunction with the accompanying drawings of which:

FIG. 1 is a schematic view illustrating an apparatus for manufacturing a color filter in accordance with example embodiments;

FIG. 2 is a detailed schematic view illustrating a pattern processing unit in accordance with example embodiments;

FIG. 3 is a detailed schematic view illustrating a first ink processing unit in accordance with example embodiments;

FIGS. 4A to 4C are views illustrating a pattern process in a method of manufacturing a color filter in accordance with example embodiments;

FIG. 5 is a perspective view illustrating manufacture of an organic film in accordance with example embodiments;

FIGS. 6A to 6C are views illustrating a first ink process in accordance with example embodiments;

FIG. 7 is a perspective view illustrating manufacture of a black matrix in accordance with example embodiments;

FIGS. 8A to 8D are views illustrating a second ink process in accordance with example embodiments;

FIG. 9 is a schematic view illustrating a color filter in accordance with example embodiments;

FIG. 10 is a schematic view illustrating a second ink processing unit of an apparatus for manufacturing a color filter in accordance with example embodiments; and

FIG. 11 is a schematic view illustrating a second ink processing unit of an apparatus for manufacturing a color filter in accordance with example embodiments.

### DETAILED DESCRIPTION

Example embodiments will now be described more fully with reference to the accompanying drawings, in which example embodiments are shown. The invention may, however, be embodied in different forms and should not be construed as limited to example embodiments set forth herein. Rather, example embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments.

Reference will now be made in detail to example embodiments, examples of which are illustrated in the accompanying drawings, wherein like reference numerals refer to like elements throughout.

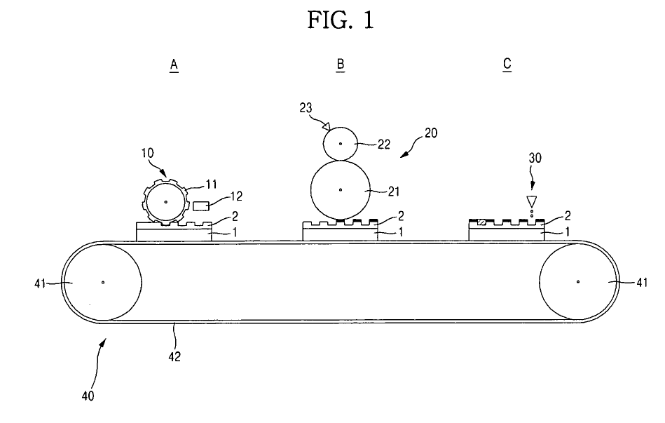

FIG. 1 is a schematic view illustrating an apparatus for manufacturing a color filter in accordance with example embodiments. The apparatus in accordance with example embodiments may include a pattern processing unit 10, a first ink processing unit 20, a second ink processing unit 30, and a transfer unit 40.

The apparatus may further include an organic film processing unit (not shown) to apply an organic material (or polymer) to a substrate 1 to form an organic film 2.

The organic film processing unit (not shown) may apply the organic material to the substrate 1 by spin coating, dispensing, blading, and/or squeezing methods. Further, the organic film processing unit (not shown) may include a blanket roller (not shown) and may apply the organic material to the substrate 1 by a roll printing method using the blanket roller (not shown).

The pattern processing unit 10 may perform imprinting on the organic film 2 applied to the substrate 1, thus a black matrix pattern and a color cell pattern on the organic film 2 may be formed.

In example embodiments, the organic film 2 may be imprinted to include barrier parts 2a forming the black matrix pattern, and groove parts 2b forming the color cell pattern. In example embodiments an organic film 2 may be made of a transparent organic material or polymer, therefore an etching process upon the groove parts 2b may not be carried out in the formation of color cells.

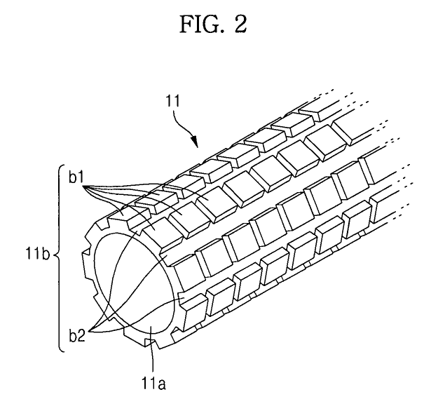

The pattern processing unit 10 may include a mold roller 11 to form the black matrix pattern (e.g., the barrier parts) and the color cell pattern (e.g., the groove parts) on the organic film 2. Hereinafter, the mold roller 11 will be described with reference to FIG. 2.

FIG. 2 is a perspective view of the mold roller 11 of the pattern processing unit 10 of the apparatus. The mold roller 11 may include a base roller 11a and an uneven sheet 11b attached to the outer circumferential surface of the base roller 11a. The uneven sheet 11b may include a plurality of prominences b1 and depressions b2 formed in a lattice shape.

The prominences b1 of the uneven sheet 11b may be formed in a shape corresponding to a pattern of color cells of R, G, and B, i.e., the three primary colors, and the depressions b2 of the uneven sheet 11b may be formed in a shape corresponding to a pattern of the black matrix (BM). That is, the uneven sheet 11b may have a prominence and depression pattern.

In example embodiments, the black matrix (BM) of the color filter serves to divide the color cells of R, G, and B from each other, block light, prevent or reduce color reproduction of R, G, and B and leakage of light, and raise a contrast.

The prominences b1 and the depressions b2 of the uneven sheet 11b of the mold roller 11 may be formed by performing a laser process on a sheet or performing a photolithography process on a sheet. In example embodiments, a height difference h1 between the prominences b1 and the depressions b2 may be adjusted when the uneven sheet 11b is formed, and thus a height difference h2 between the barrier parts 2a and the groove parts 2b formed on the organic film 2 may be easily adjusted. Thereby, during an ink-jet printing of R, G, B inks to the groove parts 2b of the organic film 2, filling conditions of three inks may be optimized, and tuning of the filling conditions of three inks may be facilitated.

The pattern processing unit 10 may further include a release agent supply unit (not shown) to supply a release agent to the uneven sheet 11b of the mold roller 11 to facilitate a separation of the organic film 2 and the mold roller 11 when the uneven sheet 11b of the mold roller 11 carries out imprinting upon the organic film 2. In example embodiments, the release agent supplied from the release agent supply unit may be applied to the uneven sheet 11b of the mold roller 11.

The pattern processing unit 10 may further include a hardening unit 12 to harden the organic film 2 provided with the barrier parts 2a forming the black matrix pattern and the groove parts 2b forming the color cell pattern. The hardening unit 12 may be a UV hardening unit to harden the organic film 2 using ultraviolet rays and/or a thermal hardening unit to harden the organic film using heat.

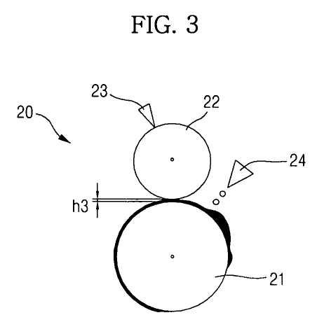

The first ink processing unit 20 may form a black matrix 3 on the organic film 2 by roll printing a first ink i1 on the organic film 2. The first ink i1 may be printed on the plural barrier parts 2a protruding from the organic film 2. Thereby, the first ink i1 printed on the plural barrier parts 2a of the organic film 2 may form the black matrix (BM) 3 of the color filter. Hereinafter, the first ink processing unit 20 will be described with reference to FIG. 3.

FIG. 3 is a detailed schematic view illustrating the first ink processing unit 20 of the apparatus. The first ink processing unit 20 may include a blanket roller 21, to which the first ink i1 may be applied, an adjust roller 22 installed adjacent to the blanket roller 21 and separated from the blanket roller 21 by a designated interval h3 to uniformly adjust the thickness of the first ink i1 applied to the blanket roller 21, a blade 23 contacting the first ink i1 to remove a first ink i1 adhered to the adjust roller 22 from the adjust roller 22, and a first ink discharge head 24 to discharge the first ink i1 to the blanket roller 21.

The adjust roller 22 may be installed such that the interval h3 of the adjust roller 22 with the blanket roller 21 is adjustable, and the thickness of the first ink i1 applied to the blanket roller 21 is adjusted by adjusting the interval h3 of the adjust roller 22 with the blanket roller 21. Thereby, a thickness h4 of the black matrix formed with the first ink i1 may be adjusted. Thus, the blockage ratio of light and the leakage of light are minimized or reduced by adjusting the thickness h4 of the black matrix.

The second ink processing unit 30 may perform ink-jet printing, in which second inks i2 of the three primary colors of light, i.e., R, G, and B, are discharged onto the groove parts 2b of the organic film 2, and thus may form color cells 4a, 4b, and 4c of the three primary colors in the groove parts 2b of the organic film 2. Thereby, the inks i21, i22, and i23 of the three primary colors, ink-jet printed on the plural groove parts 2b of the organic film 2, form the color cells 4a, 4b, and 4c of the three primary colors of the color filter.

The second ink processing unit 30 may include a red ink discharge head 31 containing the red ink i21, a green ink discharge head 32 containing the green ink i22, and a blue ink discharge head 33 containing the blue ink i23.

The second ink discharge heads 31, 32, and 33 may move alternately, and may discharge the three inks i21, i22, and i23 of the three primary colors of light, i.e., R, G, and B, to the groove parts 2b of the organic film 2.

Further, the red ink discharge head 31, the green ink discharge head 32, and the blue ink discharge head 33 may simultaneously move, and may discharge the three inks i21, i22, and i23 of the three primary colors of light to the groove parts 2b of the organic film 2 at the same time.

The transfer unit 40 may include at least two transfer rollers 41 separated from each other, and a transfer belt 42 wound on the two transfer rollers 41. The transfer belt 42 may continuously move by the rotations of the two transfer rollers 41. In example embodiments, the two transfer rollers 41 may be rotated in the same direction.

The substrate 1 to be manufactured into the color filter may be mounted on the transfer belt 42. The pattern processing unit 10, the first ink processing unit 20, and the second ink processing unit 30 may be installed at one side of the transfer belt 42 as shown in FIG. 1. Therefore, because the transfer belt 42 may continuously move by the rotations of the two transfer rollers 41, the transfer belt 42 may transfer the substrate 1 to a position corresponding to a next processing unit.

When the color filter is manufactured, the black matrix BM may be formed by carrying out imprinting and printing using the rollers, as described above. All processes of forming the black matrix may be achieved by a roll to roll method using the transfer unit 40, in which the transfer belt 42 moves by the transfer rollers 41.

The transfer unit 40 may further include an idler, which may be located between the two transfer rollers 41 and may support the transfer belt 42 to prevent the transfer belt 42 from sagging or reduce a sagging in the transfer belt 42.

Plural transfer units 40 may be provided. In example embodiments, the transfer units 40 may be respectively installed at the positions of the respective processing units 10, 20 and 30 to achieve respective processes A, B, and C. Alternately, one transfer unit of the plural transfer units 40 may be installed at a position corresponding to the positions of the pattern processing unit 10 and the first ink processing unit 20 to perform the pattern process A and the first ink process B, and the other transfer unit of the plural transfer units 40 may be installed at a position corresponding to the position of the second ink processing unit 30 to perform the second ink process C.

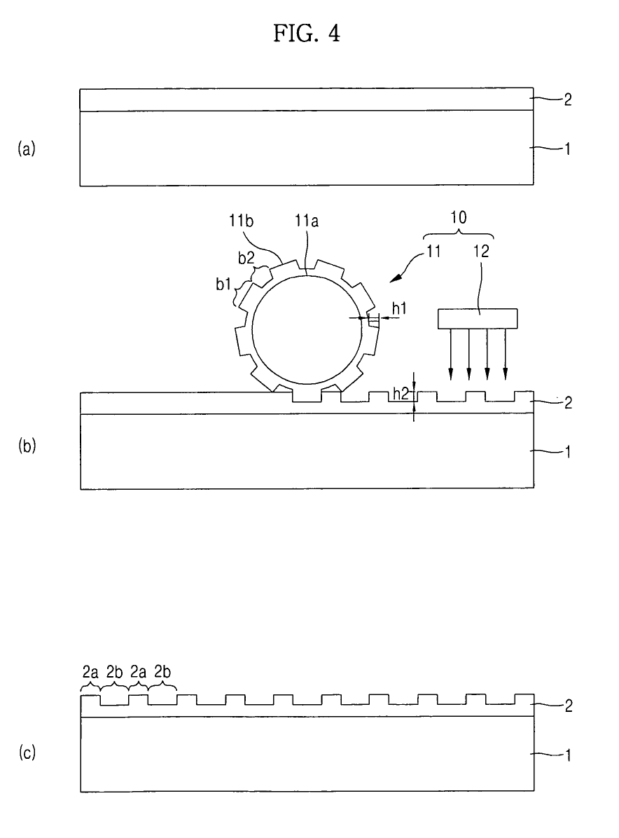

FIGS. 4A to 8D are views illustrating a method of manufacturing a color filter in accordance with example embodiments.

FIGS. 4A to 4C are views illustrating the pattern process A in the method in accordance with example embodiments.

In FIG. 4A, the substrate 1 is seated on the transfer belt 42 of the transfer unit 40, and the organic film 2 is formed on the substrate 1. The organic file 2 may be formed on the substrate 1 by applying a transparent organic material or polymer in a liquid state to the substrate 1 by driving an organic film processing unit (not shown).

A release agent may be applied to the mold roller 11 to promote a separation of the uneven sheet 11b of the mold roller 11 from the organic film 2.

In example embodiments, the two transfer rollers 41 of the transfer unit 40 may be rotated to move the transfer belt 42. Accordingly, the substrate 1 provided with the organic film 2 may be moved towards the mold roller 11 by the movement of the transfer belt 42. In example embodiments, the substrate 1 provided with the organic film 2 moves to a space between the transfer belt 42 and the mold roller 11 by the movement of the transfer belt 42 and thus the organic film 2 of the substrate 1 contacts the mold roller 11 while the substrate 1 moves due to the movement of the transfer belt 42.

As shown in FIG. 4B, when the substrate 1 is moved to the space between the transfer belt 42 and the mold roller 11, the organic film 2 applied to the substrate 1 and made of the transparent liquid is pressurized by the mold roller 11. In example embodiments, the substrate 1 moves under the condition that the organic film 2 is pressurized by the mold roller 11, accordingly, the barrier parts 2a and the groove parts 2b are formed on the organic film 2.

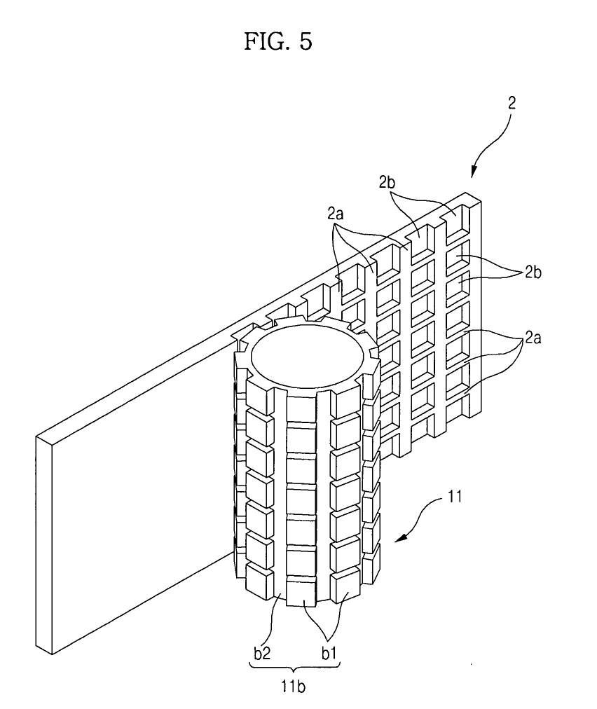

That is, as shown in FIG. 5, under the condition that the mold roller 11 applies pressure to one side of the organic film 2 applied to the substrate 1, the mold roller 11 is rotated toward the other side of the organic film 2, thus forming the barrier parts 2a and the groove parts 2b on the organic film 2. As such, the mold roller 11 performs imprinting, in which the mold roller 11 is rotated according to a movement of the substrate 1, by continuously applying pressure to the organic film 2, thus forming the barrier parts 2a and the groove parts 2b on the organic film 2.

In example embodiments, because the prominences b1 and the depressions b2 of the mold roller 1 are imprinted on the organic film 2, the prominences b1 and the depressions b2 of the mold roller 11 may be formed in a lattice shape being complementary to the lattice shape formed by the barrier parts 2a and the groove parts 2b. Further, because the prominences b1 and the depressions b2 of the mold roller 1 are imprinted on the organic film 2, the height difference h2 between the barrier parts 2a and the groove parts 2b of the organic film 2 is the same as the height difference h1 between the prominences b1 and the depressions b2 of the uneven sheet 11b.

In order to maintain the current state of the barrier parts 2a and the groove parts 2b while continuously forming the barrier parts 2a and the groove parts 2b on the organic film 2 by imprinting using the mold roller 11, the hardening unit 12 may supply ultraviolet rays UV and/or heat to the barrier parts 2a and the groove parts 2b of the organic film 2 immediately after the formation of the barrier parts 2a and the groove parts 2b, and thus may harden the barrier parts 2a and the groove parts 2b of the organic film 2.

As shown in FIG. 4C, the barrier parts 2a and the groove parts 2b corresponding to the shape of the uneven sheet 11b of the mold roller 11 may be formed on the organic film 2 by imprinting using the mold roller 11.

Further, the barrier parts 2a and the groove parts 2b corresponding to the shapes of the prominences b1 and the depressions b2 of the uneven sheet 11b may be formed on the organic film 2 by rotating the mold roller 11 using a motor driving unit (not shown) connected with the base roller 11a.

The substrate 1 provided with the organic film 2 including the barrier parts 2a and the groove parts 2b may be transferred to a position corresponding to the first ink processing unit 20 by rotating the two transfer rollers 41 of the transfer unit 40.

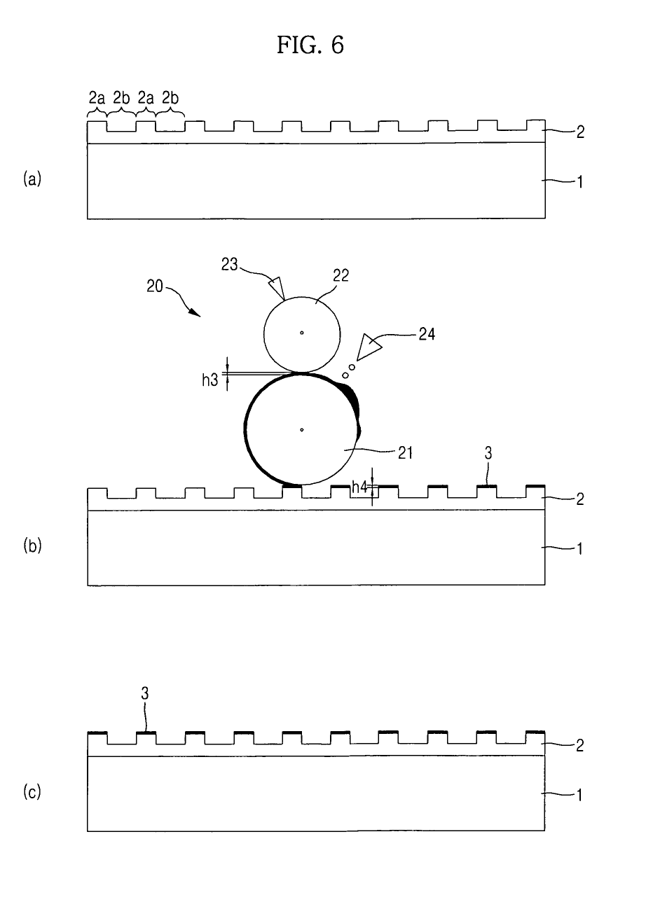

FIGS. 6A to 6C are views illustrating the first ink process B in a method in accordance with example embodiments.

When the transfer belt 42 moves due to the rotations of the two transfer rollers 41 of the transfer unit 40, the substrate 1 may be moved towards the first ink processing unit 20 by the movement of the transfer belt 42. In example embodiments, the substrate 1 has the organic film 2 including the barrier parts 2a and the groove parts 2b, as shown in FIG. 6A.

In example embodiments, the first ink discharge head 24 is driven and discharges the first ink i1 to the blanket roller 21, and thus the first ink i1 is applied to the blanket roller 21. In example embodiments, the first ink i1 is a black ink to form the black matrix.

As shown in FIG. 6B, the first ink i1 applied to the blanket roller 21 has a uniform thickness through a gap between the blanket roller 21 and the adjust roller 22. The first ink i1 adhered to the adjust roller 22 may be separated from the adjust roller 22 by the blade 23. Thereby, the first ink i1 is not accumulated on the adjust roller 22.

In example embodiments, the substrate 1 is moved between the transfer belt 42 and the blanket roller 21 by the movement of the transfer belt 42, and thus the organic film 2 contacts the blanket roller 21. In example embodiments, the substrate 1 may move due to the movement of the transfer belt 42 under the condition that the substrate 1 is transferred to a space between the transfer belt 42 and the blanket roller 21.

As shown in FIG. 6B, the substrate 1 may be transferred to the space between the transfer belt 42 and the blanket roller 21 and the barrier parts 2a of the organic film 2 may contact the blanket roller 21. Further, the substrate 1 may move under the condition that the organic film 2 contacts the blanket roller 21 by the movement of the transfer belt 42.

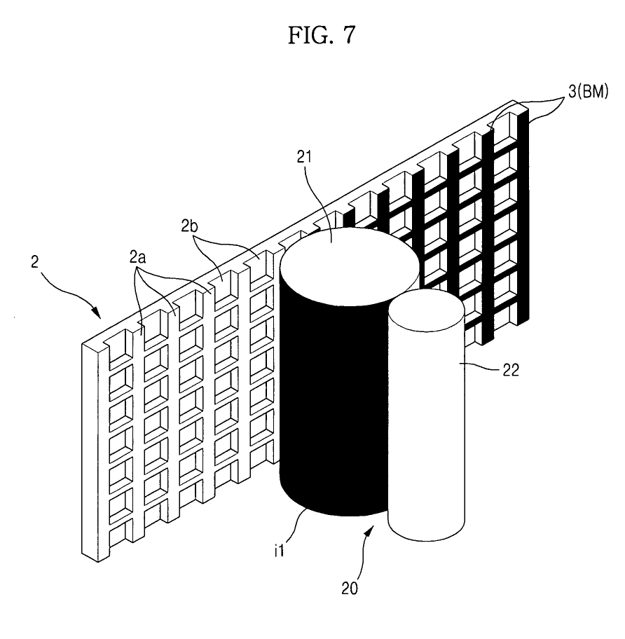

As shown in FIG. 7, the blanket roller 21 is rotated toward the other side of the organic film 2 under the condition that the blanket roller 21 contacts the barrier parts 2a of the organic film 2, and thus prints the first ink i1 to the barrier parts 2a of the organic film 2. That is, the blanket roller 21 performs roll printing, in which the blanket roller 21 is rotated by the movement of the substrate 1 and continuously contacts the organic film 2, and thus the first ink i1 is applied to the barrier parts 2a. Since the barrier parts 2a of the organic film 2 are relatively protruded compared with the groove parts 2b, the first ink i1 is printed only on the barrier parts 2a of the organic film 2.

As shown in FIG. 6C, the blanket roller 21 may continuously contact the barrier parts 2a of the organic film 2 by roll printing using the blanket roller 21, and thus the first ink i1 may be applied to the barrier parts 2a on the entire surface of the organic film 2, thereby forming a black matrix.

Further, the first ink i1 may be printed to the barrier parts 2a of the organic film 2 by rotating the blanket roller 21 using a motor driving unit (not shown) connected with the blanker roller 21.

The substrate 1 provided with the black matrix may be transferred to a position corresponding to the second ink processing unit 30 by rotating the two transfer rollers 41 of the transfer unit 40.

In the color filter manufacturing method in accordance with example embodiments, as shown in FIGS. 4 to 7, since the black matrix BM of the color filter is formed by the roll to roll method using the mold roller 11 and the blanket roller 21 installed at one side of the transfer unit 40, a large amount of heat is not applied to the substrate 1 or a chemical agent is not used. Therefore, the substrate 1 may employ not only a glass substrate but also a flexible substrate made of polyethylene terephthalate (PET), polyethylene naphthalene (PEN), or polyether sulfone (PES).

Thereby, since the color filter may be manufactured using a flexible substrate, a flexible display may be easily manufactured at low costs and may have a drastically reduced price, and thus may be popularized. Further, the color filter may be manufactured by the roll to roll method, and the manufacturing speed of the color filter may be increased or maximized.

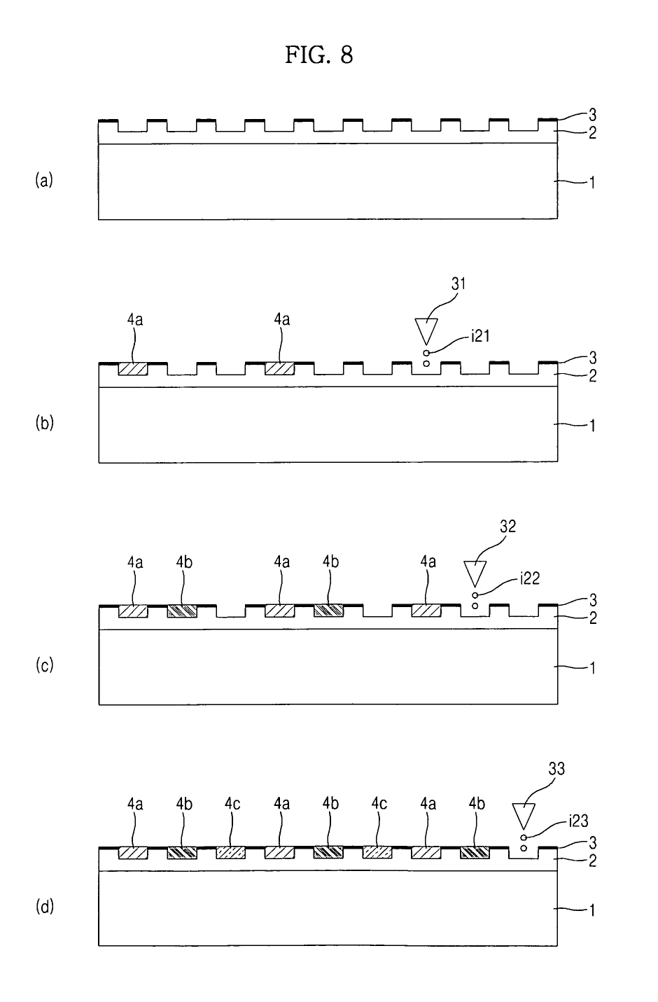

FIGS. 8A to 8D are views illustrating the second ink process C in a method in accordance with example embodiments.

In example embodiments, the transfer belt 42 may move due to the rotations of the two transfer rollers 41 of the transfer unit 40 and the substrate 1 may move to the second ink processing unit 30 by the movement of the transfer belt 42. The substrate 1 may have the organic film 2 provided with the black matrix 3, as shown in FIG. 8A.

The second ink discharge heads 31, 32, and 33 may be alternately driven and may respectively discharge second inks i2 to the groove parts 2b of the organic film 2. As shown in FIG. 8B, the red ink discharge head 31 containing the red ink i21 may be driven and may discharge the red ink i21 to the groove parts 2b of the organic film to form red color cells 4a. As shown in FIG. 8C, the green ink discharge head 32 containing the green ink i22 may be driven and may discharge the green ink i22 to the groove parts 2b of the organic film to form green color cells 4b. As shown in FIG. 8D, the blue ink discharge head 33 containing the blue ink i23 may be driven and may discharge the blue ink i23 to the groove parts 2b of the organic film to form blue color cells 4c. Thereby, color cells 4a, 4b, and 4c of R, G, and B may be formed on the organic film 2.

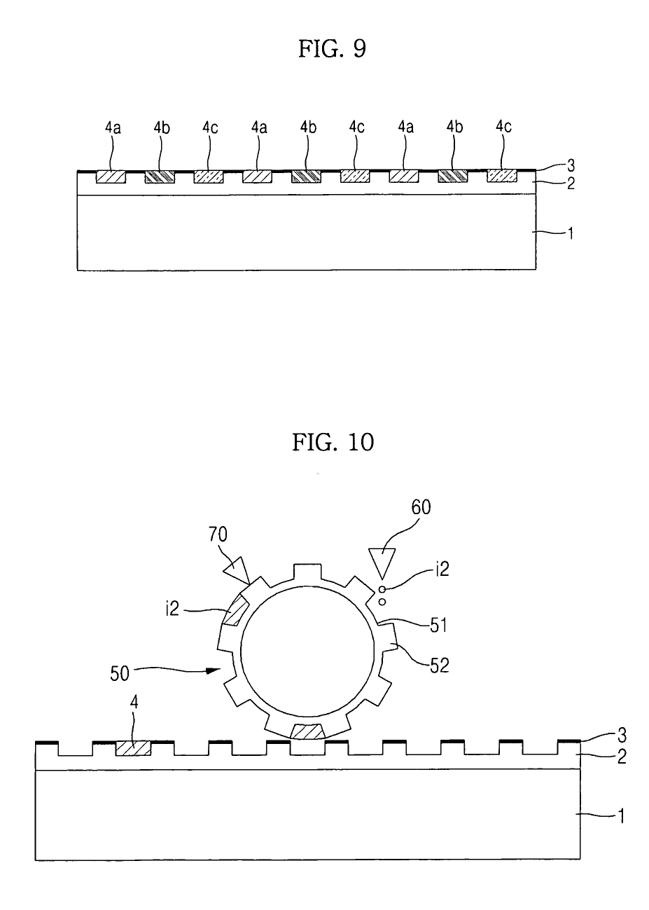

FIG. 9 is a schematic view illustrating a color filter in accordance with example embodiments.

The color filter may include the substrate 1, the organic film 2 applied to the substrate 1, and the black matrix 3. In example embodiments, the substrate 1 may include the barrier parts 2a and the groove parts 2b and the black matrix 3 may be formed on the barrier parts 2a by applying the first ink i1 to the barrier parts 2a. Additionally, the R, G, and B color cells 4a, 4b, and 4c may be formed in the groove parts 2b of the organic film 2 by applying the second inks i2 of the three primary colors to the groove parts 2b.

The substrate 1 may be a flexible substrate made of polyethylene terephthalate (PET), polyethylene naphthalene (PEN), or polyether sulfone (PES) as well as a glass substrate.

The organic film 2 may be made of a transparent organic material or polymer. The organic film 2 may include the barrier parts 2a having a prominence shape and the groove parts 2b having a depression shape. Here, the organic film 2 may be transparent to form color cells on the groove parts 2b. The plural barrier parts 2a of the organic film 2 may form a black matrix pattern, and the plural groove parts 2b formed between the plural barrier parts 2a may form a color cell pattern. That is, the black matrix 3 may be formed on the plural barrier parts 2a of the organic film 2, and the color cells 4a, 4b, and 4c of the three primary colors may be formed on the plural groove parts 2b.

FIG. 10 is a schematic view illustrating a second ink processing unit of an apparatus of manufacturing a color filter in accordance with example embodiments.

The second ink processing unit illustrated in FIG. 10 may include an ink processing roller 50, a plurality of ink discharge parts 60, and a blade 70. In example embodiments, the ink processing roller 50 may have depressions 51 and prominences 52 and the plurality of ink discharge parts 60 may respectively discharge second inks i2 of the three primary colors to the depressions 51 of the ink processing roller 50. The blade 70 may be installed at a position, which may contact the prominences 52 of the ink processing roller 50, to remove the inks i2 adhered to the prominences 52.

In the second ink process using the second ink processing unit, the second inks i2 of the three primary colors may be alternately discharged to the depressions 51 of the ink processing roller 50. In example embodiments, the ink processing roller 50 may be rotated under the condition that the prominences 52 contact the blade 70. Thus the blade 70 may remove the second inks i2 adhered to the prominence 52 of the ink processing roller 50.

The substrate 1 may move due to the driving of the transfer unit 40, and the prominences 52 of the ink processing roller 51 may contact and apply pressure to the barrier parts 2a of the organic film 2 by the rotation of the ink processing roller 50. In example embodiments, the prominences 52 of the ink processing roller 50 may be pressed onto the barrier parts 2a of the organic film 2 due to the elasticity of the prominences 52, and the second inks i2 received in the depressions 51 of the ink processing roller 50 may be injected into the groove parts 2b of the organic film 2.

The second inks i2 of the primary three colors may be sequentially injected into the plural groove parts 2b of the organic film 2 by the above method, thus forming color cells 4 of the color filter. That is, the R, G, and B color cells 4 may be formed on the organic film 2 by a gravure printing method.

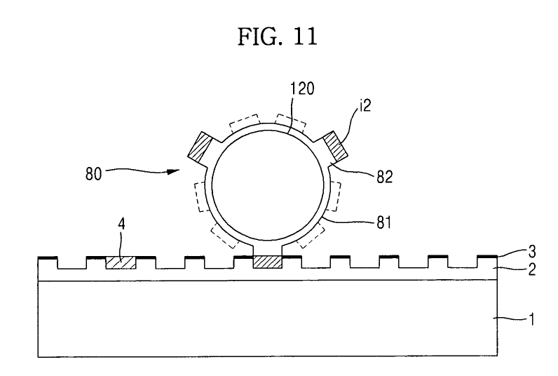

FIG. 11 is a schematic view illustrating a second ink processing unit of an apparatus for manufacturing a color filter in accordance with example embodiments.

The second ink processing unit illustrated in FIG. 11 may include an ink processing roller 80 having depressions 81 and prominences 82, and a plurality of ink discharge parts (not shown) alternately discharging second inks i2 of the three primary colors to the prominences 82 of the ink processing roller 80.

In the second ink process using the second ink processing unit, when the second inks i2 of the three primary colors are alternately discharged to the prominences 82 of the ink processing roller 80, the second inks i2 are applied to the prominences 82 of the ink processing roller 80.

In example embodiments, the substrate 1 may move due to the driving of the transfer unit 40 and the ink processing roller 80 may be rotated. Accordingly, the prominences 82 of the ink processing roller 80 may be rotated into the groove parts 2b of the organic film 2. In example embodiments, the second inks i2 that may be applied to the prominences 82 of the ink processing roller 80 may be injected into the groove parts 2b of the organic film 2.

The second inks i2 of the primary three colors that may be injected into the plural groove parts 2b of the organic film 2 by the above method may form color cells 4 of the color filter. That is, the R, G, and B color cells 4 may be formed on the organic film 2 by a flexo printing method.

As is apparent from the above description, in one aspect of the disclosure, the black matrix may be formed by carrying out imprinting and printing on the organic film applied to the substrate, and may have a fine line width of a nano level by imprinting and printing.

In accordance with example embodiments, a pattern of the black matrix and a pattern of color cells may be formed on the organic film by carrying out imprinting on the organic film applied to the substrate, and the black matrix and the color cells may be respectively formed on the respective patterns. Therefore, an etching process to remove residual films of the black matrix and the color cells is not required, and thus a manufacturing process of the color filter may be relatively simple. Thereby, a cost for equipment required by the etching process and material costs may be reduced, manufacturing time may be shortened, and thus, the color filter may be manufactured at a relatively low cost. Further, the price of a flat display device having the color filter, for example, an LCD, may be lowered.

In accordance with example embodiments, the height difference between the depressions and the prominences of the uneven sheet provided on the mold roller to carry out imprinting may be adjusted, and thus the height between the barrier parts and the groove parts formed on the organic film may be easily adjusted. Thereby, when the color cells are formed on the organic film, tuning of the filling conditions of color inks may be facilitated.

In accordance with example embodiments, because the thickness of the ink applied to the blanket roller to carry out printing may be varied by adjusting the interval between the blanket roller and the adjust roller, the thickness of the black matrix may be easily adjusted and the blockage ratio of light and the leakage of light may be reduced or minimized by adjusting the thickness of the black matrix.

In accordance with example embodiments, because the black matrix and the color cells may not be formed on the substrate by moving the substrate whenever the respective processes are carried out, but are formed on the substrate by carrying out imprinting and printing by a roll to roll method, a flexible substrate may be used as the substrate. Therefore, a flexible color filter may be easily manufactured. Further, the flexible color filter manufactured by the roll to roll method may be applied to a flexible display, and thus the price of a flexible display may be lowered and the flexible display may be popularized.

Although example embodiments have been shown and described, it would be appreciated by those skilled in the art that changes may be made in these embodiments without departing from the principles and spirit of the invention, the scope of which is defined in the claims and their equivalents.

What is claimed is:

1. A method of manufacturing a color filter comprising:
forming an organic film on a substrate;
forming a pattern on the organic film by applying pressure to the organic film with a mold having prominences and depressions; and
forming a black matrix and a plurality of color cells by applying ink to the pattern on the organic film.

2. The method according to claim 1, wherein applying pressure to the organic film with the mold includes applying a release agent to the mold having the prominences and the depressions.

3. The method according to claim 1, wherein forming the pattern on the organic film includes forming a plurality of barrier parts and groove parts on the organic film.

4. The method according to claim 3, wherein forming the black matrix and the plurality of color cells includes forming the black matrix on the plurality of barrier parts and forming the color cells in the plurality of groove parts.

5. The method according to claim 4, wherein forming the color cells in the plurality of groove parts uses one of an ink-jet method, a gravure printing method, and a flexo printing method using a roller.

6. The method according to claim 1, wherein applying pressure to the organic film with the mold having the prominences and depressions includes rotating a mold roller having the prominences and depressions to apply pressure to the organic film.

7. The method according to claim 1, wherein applying the ink to the pattern on the organic film includes applying the ink to a blanket roller and printing the ink on the organic film using the blanket roller.

8. The method according to claim 7, wherein printing the ink on the organic film using the blanket roller uses a roll to roll method, in which the substrate moves using transfer rollers.

9. The method according to claim 1, wherein forming the pattern on the organic film includes hardening the pattern of the organic film by providing one of heat and light to the pattern on the organic film.

10. An apparatus for manufacturing a color filter comprising:
a pattern processing unit configured to apply pressure to an organic film on a substrate to form a plurality of barrier parts on the organic film; and
an ink processing unit configured to apply an ink to the plurality of barrier parts to form a black matrix.

11. The apparatus according to claim 10, wherein
the pattern processing unit includes an uneven sheet having a plurality of prominences and depressions, and
the plurality of barrier parts corresponds to a shape of the uneven sheet.

12. The apparatus according to claim 11, further comprising:
another ink processing unit configured to discharge red, green, and blue inks to a plurality of groove parts to form color cells on the organic film, wherein the plurality of groove parts is between the plurality of barrier parts.

13. The apparatus according to claim 10, further comprising:
a transfer unit including transfer rollers and a transfer belt wound on the transfer rollers and moving by the rotations of the transfer rollers, wherein the transfer belt is configured to seat the substrate and the pattern processing unit and the ink processing unit are at one side of the transfer unit.

14. The apparatus according to claim 10, wherein the pattern processing unit includes a mold roller having an uneven sheet and the uneven sheet has a plurality of prominences and depressions.

15. The apparatus according to claim 10, wherein the pattern processing unit includes a hardening unit configured to harden the organic film.

16. The apparatus according to claim 10, wherein the ink processing unit includes a blanket roller to which the ink is applied, and the blanket roller is configured to print the ink to the organic film.

17. The apparatus according to claim 16, wherein the ink processing unit further includes
an adjust roller separated from the blanket roller, the adjust roller and the blanket roller being adjustably arranged to adjust a thickness of the ink applied to the blanket roller, and
a blade contacting the adjust roller to remove ink adhered to the adjust roller.

18. A color filter comprising:
a substrate;
an organic film on the substrate, the organic film having an uneven pattern;
a black matrix on the uneven pattern; and
color cells in the uneven pattern.

19. The color filter according to claim 18, wherein the organic includes a transparent organic material.

20. The color filter according to claim 18, wherein the substrate is one of a glass substrate and a flexible substrate, and is one of polyethylene terephthalate (PET), polyethylene naphthalene (PEN), and polyether sulfone (PES).
